(19) United States
(12) Patent Application Publication
(10) Pub. No.: US 2014/0263846 A1
(43) Pub. Date: Sep. 18, 2014

(54) CENTRIFUGAL FORCE AMPLIFICATION METHOD AND SYSTEM FOR GENERATING VEHICLE LIFT

(71) Applicant: William R. Crowe, Port Haywood, VA (US)

(72) Inventor: William R. Crowe, Port Haywood, VA (US)

(21) Appl. No.: 13/975,420

(22) Filed: Aug. 26, 2013

Related U.S. Application Data
(60) Provisional application No. 61/776,916, filed on Mar. 12, 2013.

(51) Int. Cl. B64G 1/40

(52) U.S. Cl. CPC B64G 1/409
USPC 244/171.1

(57) ABSTRACT

A method and system generate lift for a vehicle relative to a planetary body rotating at a rotational speed. The vehicle incorporates two concentric lift rings in a common plane. The lift rings are positioned such that their common plane is approximately perpendicular to a force of gravity on the planetary body. The lift rings are rotated in opposing directions at speeds that are at least 20 times greater than the rotational speed of the planetary body.

Pursuant to 35 U.S.C. §119, the benefit of priority from provisional application 61/776,916, with a filing date of Mar. 12, 2013, is claimed for this non-provisional application.

### FIELD OF THE INVENTION

The invention relates generally to vehicles for long-distance air and space travel, and more particularly to a method and system for generating vehicle lift that uses and amplifies a rotating planetary body's centrifugal force for long-distance air and space travel.

### BACKGROUND OF THE INVENTION

Long-distance air and space travel are achieved using vehicles that burn fuel to generate propulsion forces. In the case of long distance air travel, vehicle lift must be supplied continuously. In both air and space travel, the weight of the fuel is a substantial amount of overall vehicle weight. Thus, the combined weight of the vehicle and its fuel must be overcome to lift and propel the vehicle into the air or space. In the case of space vehicles, the percentage of fuel to overall vehicle weight (also known as “mass fraction”) typically is in the range of 80-90%. That is, 80-90% of the weight of a space vehicle's “vehicle-plus-fuel combination” is the result of fuel. The requirement for so much combustible fuel presents efficiency, cost, and safety issues.

### SUMMARY OF THE INVENTION

Accordingly, it is an object of the present invention to provide a method and system for generating vehicle lift for air and space travel.

Another object of the present invention is to provide an air and space vehicle lift generation method and system that is efficient, cost effective, and inherently safe.

Other objects and advantages of the present invention will become more obvious hereinafter in the specification and drawings.

In accordance with the present invention, a method and system are provided for generating lift for a vehicle relative to a planetary body rotating at a rotational speed. The vehicle incorporates two concentric lift rings in a common plane and having a common center. The lift rings are positioned such that their common plane is approximately perpendicular to a force of gravity on the planetary body. The lift rings are rotated in opposing directions in the rings' common plane at speeds that are at least 20 times greater than the rotational speed of the planetary body.

### BRIEF DESCRIPTION OF THE DRAWINGS

Other objects, features and advantages of the present invention will become apparent upon reference to the following description of the preferred embodiments and to the drawings, wherein corresponding reference characters indicate corresponding parts throughout the several views of the drawings and wherein:

FIG. 1 is a schematic plan view of the motion and force generating elements associated with a centrifugal force amplification method and system for generating vehicle lift in accordance with an embodiment of the present invention;

FIG. 2 is a side view of a centrifugal force amplification vehicle of the present invention and a portion of a rotating planetary body;

FIG. 3 is a diagrammatic plan view of a centrifugal force amplification vehicle's movement along a planetary body's rotational velocity vector;

FIG. 4A is a schematic sectional view of a centrifugal force amplification vehicle's counter-rotating ring structure in accordance with an embodiment of the present invention;

FIG. 4B is a schematic plan view of a centrifugal force amplification vehicle's counter-rotating ring structure in accordance with an embodiment of the present invention;

FIG. 5 is a schematic plan view of the motion and force generating elements associated with a centrifugal force amplification vehicle equipped with lift vector adjustment in accordance with another embodiment of the present invention;

FIG. 6 is a schematic plan view of a centrifugal force amplification vehicle's counter-rotating lift compensating-ring structure in accordance with an embodiment of the present invention;

FIG. 7 is a schematic plan view of the motion and force generating elements associated with a centrifugal force amplification vehicle equipped with lift vector adjustment in accordance with yet another embodiment of the present invention;

FIG. 8 is a schematic side view of a general vehicle shape for a centrifugal force amplification vehicle in accordance with an embodiment of the present invention; and

FIG. 9 is a schematic plan view of a centrifugal force amplification vehicle's counter-rotating ring structure to include torque/yaw damping compensation in accordance with another embodiment of the present invention.

### DETAILED DESCRIPTION OF THE INVENTION

A centrifugal force amplification vehicle constructed in accordance with the present invention utilizes the motion and forces associated with counter rotating rings to generate lift for the vehicle. When the vehicle is positioned such that the vehicle's motion and forces are combined with the centrifugal force generated by a rotating planetary body (e.g., Earth, Mars, etc.), the vehicle becomes an efficient long-distance air or space vehicle having minimal or no combustible fuel requirements. As will be explained further below, the overall shape and size of the vehicle could approximate or mimic the shape/size defined by the vehicle's counter rotating rings. The vehicle could also incorporate a variety of other known aerodynamic materials and structures/systems (e.g., aerodynamic shaping, control surfaces, thrusters, etc.) without departing from the scope of the present invention. However, in order to clearly illustrate the operating principles of the present invention's centrifugal force amplification method and system for generating vehicle lift, the vehicle's outer mechanical structure is only referenced generally in FIGS. 1-7.

Referring now to the drawings and more particularly to FIGS. 1 and 2, the motion and force generating elements associated with a centrifugal force amplification vehicle are illustrated, while the vehicle structure is indicated generally by the dashed line circle referenced by numeral 10 in FIG. 1 and by the dashed line rectangle referenced by numeral 10 in FIG. 2. The view presented in FIG. 1 is a plan or top view of vehicle 10 positioned over a rotating planetary body 100 (e.g., Earth, Mars, etc.) rotating at a known speed along a direction of rotation vector referenced by numeral 102. The view presented in FIG. 2 is a side view of vehicle 10 and a portion of rotating planetary body 100. As is well known in the art, when planetary body is Earth, the velocity thereof designated as V_{EARTH} is approximately 1000 miles per hour at the Earth's equator and direction of rotation vector 102 points due east.

Vehicle 10 includes two counter rotating rings 12 and 14. A portion of each rotation of rings 12 and 14 is coincident with direction of rotation 102 of planetary body 100. Exemplary construction of rings 12 and 14 will be provided later herein. For purpose of describing the operating principles of the present invention, it is sufficient to say that each of rings 12 and 14 rotates at a speed that is much greater than the rotational speed of planetary body 100. When planetary body 100 is Earth, the rotational speed for each of rings 12 and 14 needs to be on the order of at least 20-30 times the rotational speed of Earth. The relative speed of rings 12/14 (as compared to the rotational speed of planetary body 100) needed to produce vehicle lift is predicated on a number of factors with the most influential of these factors being gravitational forces (or the acceleration force of gravity) on planetary body 100, radius of planetary body 100, rate of rotation of planetary body 100, and latitudinal location of vehicle 10 on planetary body 100. If a planetary body's gravitational force is less than that of Earth or its radius is smaller than that of Earth (e.g., as is the case on Mars), the speed of rings 12/14 may not need to be 20-30 times greater than the rotational speed of planetary body 100.

Rings 12 and 14 lie in the same plane, are concentric such that they have a common center 13, and are radially spaced apart from one another throughout their operation. Ideally, the plane encompassing rings 12/14 is perpendicular (or approximately so) to the planetary body's force of gravity F_{g} acting thereon as illustrated in FIG. 2. In the illustrated embodiment, ring 12 rotates clockwise while ring 14 rotates counter clockwise as illustrated by the directional arrowheads on the illustration of the rings. However, it is to be understood that ring 12 could rotate counter clockwise and ring 14 could rotate clockwise without departing from the scope of the present invention.

As rings 12 and 14 are rotated at the above-described high rate of speed (as compared to that of planetary body 100), each ring 12 and 14 travels a diametric distance coincident with the planetary body's direction of rotation vector 102. This is illustrated in FIG. 3 where the dashed line version of vehicle 10 shows its position at a time t₀ and the solid line version of vehicle 10 shows its position at a later time t₁. For clarity of illustration, rings 12 and 14 are not illustrated in FIG. 3.

The diameter of vehicle 10 is defined as X and the diametric distance that vehicle 10 travels between times t₀ and t₁ (due to the rotating speed of planetary body 100) is defined as Y where diametric distance Y is aligned with direction of rotation vector 102. Since rings 12 and 14 (illustrated in FIGS. 1 and 2) are rotating at speeds greater than that of the planetary body's speed of rotation, vehicle 10 amplifies the centrifugal force generated by planetary body 100 thereby generating lift. More specifically, since centrifugal force is a squared function, the aft moving portion of the ring (i.e., where aft is relative to the direction of rotation of the planetary body) always produces less lift than the forward moving portion. That is, the aft moving portion of ring 12 occurs as ring rotates from position 12A to position 12B while the forward moving portion of ring 12 occurs as ring 12 rotates from position 12B to position 12A. A similar situation occurs for ring 14. Taken alone, the lift force generated by each rotating ring 12 and 14 also produces a torque about common center 13 resulting in a yaw force acting on the vehicle. However, the counter rotation of rings 12 and 14 neutralizes the two torque forces. Thus, the resulting sum of the lifts created by the forward and aft motion of the counter rotating rings combined with the rotation of planetary body 100 results in a stabilized center of lift (i.e., minimal or no torque generated about common center 13) being forward of common center 13 of counter rotating rings 12 and 14.

An exemplary construction for the counter rotating rings for incorporation in a centrifugal force amplification vehicle will now be explained with the aid of FIGS. 4A and 4B. Each of rings 12 and 14 is cylindrical (i.e., circular in cross section) and is made from a material that at least includes magnetic material or is completely made from a magnetic material. Rings 12 and 14 can also incorporate high tensile strength materials so that rings 12 and 14 retain their shape as they are rotated. Each of rings 12 and 14 is housed in its own cylindrical tunnel 22 and 24. Each of tunnels 22 and 24 is constructed and maintained to define and/or create an evacuated space 32 and 34 about rings 12 and 14, respectively. Vacuum pumps 42 and 44 (visible only in FIG. 4A) could be coupled to tunnels 22 and 24, respectively, to maintain the needed vacuum. Tunnels 22 and 24 are separated from one another for reasons that will be explained further below. Tunnels 22 and 24 are made completely or at least partially from a superconducting material such that the magnetic-material-based rings 12 and 14 are pushed or suspended within evacuated spaces 32 and 34, respectively, owing to what is well known in the art as the Meissner effect.

To generate rotational motion of rings 12 and 14 in their tunnels, a motive force must be applied to each of rings 12 and 14. One scheme for generating the needed rotation-generating force is illustrated in FIGS. 4A and 4B where a number of linear induction motors (“LIM”) 52 and 54 are distributed about tunnels 22 and 24, respectively, along what will become the rotational direction of the respective rings. A controller 56 can be coupled to LIMB 52 and 54 for the individual control and energizing thereof. For clarity of illustration, only one such “coupling” is shown in the figures. When the linear induction motors associated with a corresponding one of the rings are periodically energized in a rotational pattern, the magnetic material in that tunnel's ring reacts to the applied induction forces causing the ring to rotate. For pure lift generation in a stable (or torque neutral) fashion, the forces applied by LIMB 52 to ring 12 are the same as the forces applied by LIMB 54 to ring 14. However, as will be explained further below, the forces applied by the LIMB can be adjusted (i.e., to yield an applied force differential between rings 12 and 14) to generate steering forces for the vehicle housing rings 12/14 and their rotation-force generating systems.

The superconducting attributes of tunnels 22 and 24 keep rings 12 and 14 suspended in their evacuated spaces 32 and 34 such that rings 12 and 14 experience virtually no resistance as they are rotated. The minimal-to-no resistance between rings 12/14 and tunnels 22/24 facilitates the rotation of rings 12 and 14 at high rates of speed. In addition, tunnels 22/24 supplement the strength of rings 12/14 since the tunnels magnetically center the rings therein.

As mentioned above, the plane defined by rings 12 and 14 is ideally oriented perpendicular (or approximately so) to the force of gravity F_{g} (see FIG. 2). For maximum efficiency, this orientation should be maintained as long as the vehicle is subject to the planetary body's force of gravity. However, the counter rotating ring structure described above will generate lift (i.e., a force coming up out of the plane of the paper in FIG. 5) in a region of the vehicle that lies forward of the rings' common center 13 relative to the forward moving portions of the rings that coincide with the direction of rotation vector of the rotating planetary body. This is illustrated in FIG. 5 where the lift forces for vehicle 10 occur in the region designated by dashed line box 50. It is to be understood that the size of region 50 has been exaggerated for purposes of illustrations.

As is evident in FIG. 5, lift region 50 is not at the common center 13 of rings 12 and 14. This is because lift is experienced by vehicle 10 at a position thereon that leads the origination of the lift force by 90°. Since the greatest speed of rings 12/14 occurs where ring rotation is aligned with direction of rotation vector 102, the aft moving ring (in any given rotation of the rings) produces less lift (i.e., centrifugal force) than the forward moving portion that occurs 90° later at the front and back of each ring. The vector sum of these lifts results in the center of lift being forward of common center 13. With increasing speed of the rings, the center of lift approaches alignment with common center 13 although it can never be aligned with common center 13.

Since lift region 50 is not aligned with common center 13, the orientation of the plane defined by rings 12 and 14 with respect to the force of gravity will change and will not remain perpendicular thereto. This will diminish lift (i.e., centrifugal force generation) because it is the fore and aft travel of rings 12 and 14 that creates the centrifugal force.

In order to counteract the off-center location of lift region 50 and maintain the plane of rings 12/14 perpendicular to the planetary body's force of gravity, a vehicle constructed in accordance with the present invention could include a second set of counter rotating rings referenced generally by numeral 60. Ring set 60 includes counter rotating rings 62 and 64 that lie in a common plane that coincides with the plane defined by rings 12 and 14. Rings 62 and 64 have a common center 63 and can be constructed/rotated in the same fashion as rings 12 and 14; however, the rings and their rotation-force-generating components (e.g., evacuated tunnels 72/74, LIMB 82/84 distributed about tunnels 72/74, and a controller 86 for controlling/energizing rings 62/64 to generate opposing rotation of rings 62/64 as shown in FIG. 6) will be considerably smaller. The counter rotating directions of rings 62/64 can be the same (as shown) or opposite that of rings 12/14 without departing from the scope of the present invention.

In general, ring set 60 is positioned such that its common center 63 is offset from common center 13, e.g., aft of common center 13 relative to the forward direction of vehicle 10 or the direction defined by the planetary body's direction of rotation vector 102. In this way, ring set 60 generates a lift adjustment force/vector that compensates for the off-center location of lift region 50. Ring set 60 is operated to generate a compensating lift force that maintains the orientation of the rings' rotational plane perpendicular to the force of gravity as vehicle 10 travels over planetary body 100.

The compensating lift force/vector generated by ring set 60 can be adjusted during the course of a flight of vehicle 10. Such adjustment can be achieved in a variety of ways without departing from the scope of the present invention. For example, the position of ring set 60 can be fixed relative to rings 12/14 with adjustment of the compensating force/vector being accomplished by varying the rotational speeds of rings 62 and 64. Another option for adjusting the compensating lift force/vector is illustrated in FIG. 7 where vehicle 10 includes a container 66 that houses ring set 60 in a way that allows for fore/aft position adjustment of ring set 60 in the plane of rings 12/14 as indicated by two headed arrow 68. In this version, the rotational speeds of rings 62 and 64 could be fixed while the fore/aft position of ring set 60 is changed to adjust the compensating lift force/vector. Another option is to equip vehicle 10 with both types of compensating lift force/vector adjustment by providing for movement of set 60 within container 66, while also providing for rotational speed variation of rings 62 and 64.

Steering of a vehicle equipped with the lift generation system of the present invention can be accomplished in a variety of ways without departing from the scope of the present invention. For example, the vehicle could include a variety of control surfaces used to direct air flow in a desired way to implement directional control when the vehicle is flying in an atmosphere. Additionally or alternatively, the vehicle could include strategically placed combustible-fuel thrusters used to impart small amounts of steering propulsion in atmospheric and/or space regions. Still further, the structure of the rings/tunnels described above could be used to steer the vehicle. For example, tunnels 22/24 could be constructed to allow small movement of the tunnels such that a small force could be applied to each ring/tunnel at a position thereon that is 90° before the direction of desired movement thereby supporting changes in speed and direction. Note that this could also require application of a corresponding additional rotation-generating force to the rings to maintain their speed (and ultimately lift) as the ring speed would decrease when energy is taken to change the speed or direction of the vehicle. As mentioned above, the small (steering) force could also be generated by changing the amount of rotation-generating force applied to the rings to create a rotation force differential.

In general, air or space travel's greatest expenditure of energy occurs when a vehicle must first be lifted into the air. In the present invention, the initial lift can be provided from an external, ground-based source since the required mass of the vehicle is greatly reduced. Reduced vehicle mass will make it possible to use a low thrust/high specific impulse power source since there is no need for rapid acceleration or deceleration. The thrust would be applied in the direction desired.

A variety of vehicle shapes can incorporate the above-described counter rotating ring design. By way of example, one type of vehicle shape is illustrated in FIG. 8 and is referenced generally by numeral 200. The general shape of vehicle 200 is that of an inverted saucer with rings 12 and 14 disposed at the circular periphery 200A thereof. In this way, vehicle 200 can employ the largest diameter rings possible to thereby maximize the efficiency of vehicle 200. A cabin or payload region 200B could be positioned above vehicle portion 200A that supports rings 12/14. As mentioned above, vehicle 200 can (and typically will) incorporate other materials, structures and systems to enhance the vehicle's movement through air and space. The particular choices of these material, structures and systems are not limitations of the present invention.

In general, the counter rotating ring structure described herein provides stabilized, torque-neutral lift for a vehicle. However, relatively small amounts of torque about the vehicle's common center could still generate yaw forces. Accordingly, the present invention could incorporate torque/yaw damping compensation. For example, FIG. 9 illustrates the counter rotating ring structure from FIG. 4B modified to include torque/yaw damping compensation features. Briefly, a yaw rate sensor 58A (e.g., mounted on tunnel 22) senses changes in yaw and provides same to controller 56. A separate “torque/yaw damping” (TYD) LIM 58B would receive power/control signals from controller 56 based on yaw conditions sensed by sensor 58A. TYD LIM 58B would be operated to make small speed adjustments to ring 12 to reduce/eliminate yaw to thereby keep the vehicle on the desired flight path. In this way, TYD LIM 58B is analogous to an aircraft's rudder although its location relative to the vehicle's direction of travel is unimportant.

Additional control systems could also be employed without departing from the scope of the present invention. For example, a speed comparator system could be used to constantly measure/compare the relative speed of the counter rotating rings and/or monitor power output of the LIMB. Controller 56 could include programming to adjust power to the LIMB to maintain a desired ring speed for stabilized lift.

The advantages of the present invention are numerous. Scale model testing of the present invention has shown that the counter rotating ring method and system amplify a planetary body's centrifugal force acting on a vehicle to provide vehicle lift. Since most of the energy needed to rotate the rings occurs at start-up, a vehicle constructed in accordance with the present invention could be initially powered using a source that is external to the vehicle and can be separated from the vehicle once the rings reach a critical speed. Such an external power source could be stationed and remain on the ground where it can serve as the initial power source for multiple vehicles. Once airborne, the above-described ring/tunnel structure will require relatively little energy to keep the rings rotating at the speeds necessary for in-air or space flight.

Although the invention has been described relative to a specific embodiment thereof, there are numerous variations and modifications that will be readily apparent to those skilled in the art in light of the above teachings. It is therefore to be understood that the invention may be practiced other than as specifically described.

What is claimed as new and desired to be secured by Letters Patent of the United States is:

1. A method of generating lift for a vehicle relative to a planetary body rotating at a rotational speed, comprising the steps of:
providing a vehicle incorporating two concentric lift rings in a common plane and having a common center;
positioning said lift rings such that said common plane is approximately perpendicular to a force of gravity on the planetary body; and
rotating said lift rings in opposing directions in said common plane at speeds that are at least 20 times greater than the rotational speed of the planetary body.

2. A method according to claim 1, further comprising the steps of:
providing two concentric compensating rings that are smaller in diameter than each of said lift rings, said compensating rings lying in a plane coincident with said common plane of said lift rings, said compensating rings having a common center;
positioning said compensating rings such that said common center thereof is offset from said common center of said lift rings; and
rotating said compensating rings in said plane thereof and in opposing directions at speeds that are at least 20 times greater than the rotational speed of the planetary body.

3. A method according to claim 2, further comprising the step of changing the speeds of said compensating rings during said step of rotating said lift rings.

4. A method according to claim 2, further comprising the step of changing a location of said common center of said compensating rings relative to said common center of said lift rings during said step of rotating said lift rings.

5. A method according to claim 2, further comprising the steps of:
changing the speeds of said compensating rings during said step of rotating said lift rings; and
changing a location of said common center of said compensating rings relative to said common center of said lift rings during said step of rotating said lift rings.

6. A centrifugal force amplification lift system, comprising:
two concentric and radially separated lift rings in a common plane and having a common center, said lift rings adapted to be positioned with said common plane approximately perpendicular to a force of gravity associated with a planetary body rotating at a rotational speed; and
a force generator coupled to said lift rings for rotating said lift rings in opposing directions in said common plane at speeds that are at least 20 times greater than the rotational speed of the planetary body.

7. A centrifugal force amplification lift system as in claim 6, further comprising:
two concentric and radially separated compensating rings that are smaller in diameter than each of said lift rings, said compensating rings lying in a plane coincident with said common plane of said lift rings, said compensating rings having a common center, said compensating rings positioned with said common center thereof being offset from said common center of said lift rings; and
a second force generator coupled to said compensating rings for rotating said compensating rings in said common plane thereof and in opposing directions at speeds that are at least 20 times greater than the rotational speed of the planetary body.

8. A centrifugal force amplification lift system as in claim 7, wherein said second force generator changes the speeds of said compensating rings as said force generator rotates said lift rings.

9. A centrifugal force amplification lift system as in claim 7, wherein a location of said common center of said compensating rings relative to said common center of said lift rings is changed as said force generator rotates said lift rings and said second force generator rotates said compensating rings.

10. A centrifugal force amplification lift system as in claim 7, wherein said second force generator changes the speeds of said compensating rings as said force generator rotates said lift rings, and wherein a location of said common center of said compensating rings relative to said common center of said lift rings is changed as said force generator rotates said lift rings and said second force generator rotates said compensating rings.

11. A centrifugal force amplification lift system as in claim 6, wherein each of said lift rings includes magnetic material and said system further comprises:
two concentric evacuated tunnels, each of said evacuated tunnels made from a superconducting material and encasing one of said lift rings wherein each of said lift rings is suspended within one of said evacuated tunnels associated therewith;
a plurality of linear induction motors distributed about each of said evacuated tunnels; and
a controller coupled to said linear induction motors for energizing said linear induction motors in a periodic fashion wherein said lift rings are forced to rotate in said opposing directions.

12. A centrifugal force amplification lift system as in claim 7, wherein each of said compensating rings includes magnetic material and said system further comprises:
two concentric evacuated tunnels, each of said evacuated tunnels made from a superconducting material and encasing one of said compensating rings wherein each of said compensating rings is suspended within one of said evacuated tunnels associated therewith;
a plurality of linear induction motors distributed about each of said evacuated tunnels; and
a controller coupled to said linear induction motors for energizing said linear induction motors in a periodic fashion wherein said compensating rings are forced to rotate in said opposing directions.

13. A centrifugal force amplification lift system, comprising:
two concentric and radially separated lift rings in a common plane and having a common center, each of said lift rings including magnetic material, said lift rings adapted to be positioned with said common plane approximately perpendicular to a force of gravity associated with a planetary body rotating at a rotational speed;
a first force generator coupled to said lift rings for rotating said lift rings in opposing directions in said common plane at speeds that are at least 20 times greater than the rotational speed of the planetary body;
two concentric and radially separated compensating rings that are smaller in diameter than each of said lift rings, each of said compensating rings including magnetic material, said compensating rings lying in a plane coincident with said common plane of said lift rings, said compensating rings having a common center, said compensating rings adapted to be positioned with said common center thereof being offset from said common center of said lift rings; and
a second force generator coupled to said compensating rings for rotating said compensating rings in said common plane thereof and in opposing directions at speeds that are at least 20 times greater than the rotational speed of the planetary body.

14. A centrifugal force amplification lift system as in claim 13, wherein said second force generator changes the speeds of said compensating rings as said first force generator rotates said lift rings.

15. A centrifugal force amplification lift system as in claim 13, wherein a location of said common center of said compensating rings relative to said common center of said lift rings is changed as said first force generator rotates said lift rings and said second force generator rotates said compensating rings.

16. A centrifugal force amplification lift system as in claim 13, wherein said second force generator changes the speeds of said compensating rings as said first force generator rotates said lift rings, and wherein a location of said common center of said compensating rings relative to said common center of said lift rings is changed as said first force generator rotates said lift rings and said second force generator rotates said compensating rings.

17. A centrifugal force amplification lift system as in claim 13, wherein said first force generator comprises:
two concentric evacuated tunnels, each of said evacuated tunnels made from a superconducting material and encasing one of said lift rings wherein each of said lift rings is suspended within one of said evacuated tunnels associated therewith;
a plurality of linear induction motors distributed about each of said evacuated tunnels; and
a controller coupled to said linear induction motors for energizing said linear induction motors wherein said lift rings are forced to rotate in said opposing directions.

18. A centrifugal force amplification lift system as in claim 13, wherein said second force generator comprises:
two concentric evacuated tunnels, each of said evacuated tunnels made from a superconducting material and encasing one of said compensating rings wherein each of said compensating rings is suspended within one of said evacuated tunnels associated therewith;
a plurality of linear induction motors distributed about each of said evacuated tunnels; and
a controller coupled to said linear induction motors for energizing said linear induction motors wherein said compensating rings are forced to rotate in said opposing directions.
